(19) United States
(12) Patent Application Publication
(10) Pub. No.: US 2010/0196074 A1
(43) Pub. Date: Aug. 5, 2010

(54) ALIGNMENT MECHANISM FOR SHEET FINISHING APPARATUS

(75) Inventors: Hiroyuki TSUCHIHASHI, Shizuoka (JP); Hiroyuki TAKI, SHIZUOKA (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/698,647

(22) Filed: Feb. 2, 2010

Related U.S. Application Data
(60) Provisional application No. 61/150,247, filed on Feb. 5, 2009.
(60) Provisional application No. 61/150,249, filed on Feb. 5, 2009.

(51) Int. Cl. G03G 15/00; B65H 39/00

(52) U.S. Cl. 399/407; 270/58.17

(57) ABSTRACT

A sheet finishing apparatus includes: a supporting unit which supports a sheet supplied from an image forming unit; a positioning unit against which a side edge of the sheet placed on the supporting unit is abutted; a moving unit which contacts a surface of the sheet placed on the supporting unit and moves the sheet in a direction toward the positioning unit; and an adjustment unit which adjusts a movement mode of the moving unit.

### CROSS-REFERENCE TO RELATED APPLICATION

This application is based upon and claims the benefit of priority from Provisional U.S. Applications 61/150,247 filed on Feb. 5, 2009 and 61/150,249 filed on Feb. 5, 2009, the entire contents of which are incorporated herein by reference.

### TECHNICAL FIELD

The present invention relates to an alignment mechanism for a sheet finishing apparatus which finishes a sheet having an image formed thereon.

### BACKGROUND

There is a sheet finishing apparatus which performs finishing such as stapling and sorting on a sheet having an image formed thereon by an image forming apparatus. The sheet finishing apparatus may have a device which aligns a sheet, using a carrying roller for carrying the sheet in the paper discharge direction.

For example, JP-A-2007-137668 discloses a device which moves an offset roller abutted against a sheet on a processing tray in a direction that intersects the carrying direction of the sheet, thereby abuts the sheet against a lateral positioning wall, and thus aligns the sheet.

However, in such a device, when the sheet is abutted against the lateral positioning wall, the sheet may flex and the sheet may rebound at the lateral positioning wall, thus causing misalignment.

Thus, it is desired that an alignment mechanism for a sheet finishing apparatus that reduces the rebounding of the sheet when the sheet is abutted against the lateral positioning wall and thus aligned and thus improves sheet alignment accuracy, should be developed.

### SUMMARY

According to an embodiment, a sheet finishing apparatus includes: a supporting unit which supports a sheet supplied from an image forming unit; a positioning unit against which a side edge of the sheet placed on the supporting unit is abutted; a moving unit which contacts a surface of the sheet placed on the supporting unit and moves the sheet in a direction toward the positioning unit; and an adjustment unit which adjusts a movement mode of the moving unit.

### DESCRIPTION OF THE DRAWINGS

FIG. 1 is a schematic view showing the configuration of a sheet finishing apparatus connected to an MFP according to a first embodiment;

FIG. 2 is a schematic view showing the configuration of the finisher according to the first embodiment;

FIG. 3 is a schematic explanatory view showing a slide mechanism of an alignment unit according to the first embodiment;

FIG. 4 is a schematic explanatory view showing the rotation of a shaft by an adjustment bar according to the first embodiment;

FIG. 5 is a schematic explanatory view showing the rise of a roller shaft by the adjustment bar according to the first embodiment;

FIG. 6 is a schematic explanatory view showing rotation characteristics of a roller motor in the cases of normal paper and thick paper according to a second embodiment; and

FIG. 7 is a schematic explanatory view showing rotation characteristics of a gear motor in the cases of normal paper and thick paper according to the second embodiment.

### DETAILED DESCRIPTION

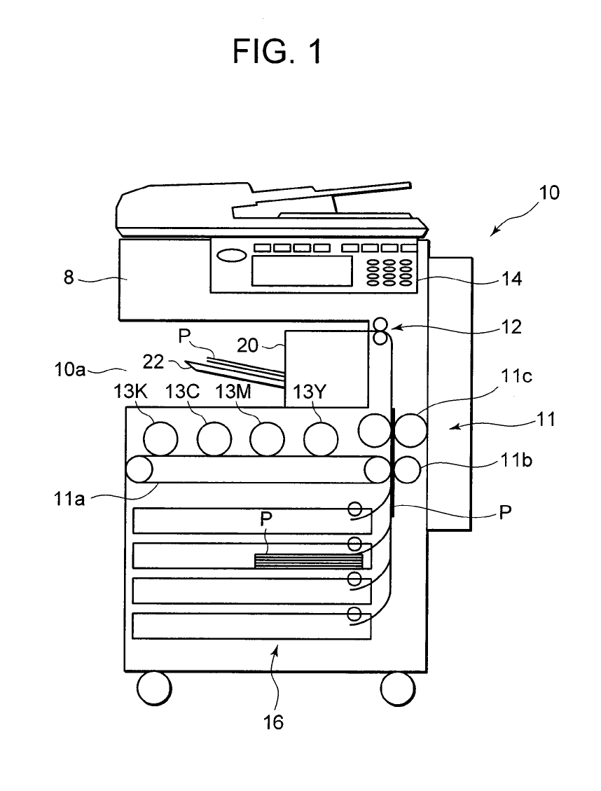

Hereinafter, a first embodiment will be described. FIG. 1 is a schematic explanatory view showing a finisher 20 as a sheet finishing apparatus connected to an MFP 10 as an image forming unit according to the first embodiment. The finisher 20 is situated within a hollow body part 10a formed in the MFP 10 and is connected to a lateral side of the MFP 10. The MFP 10 has, for example, a scanner 8, a printer unit 11, a control panel 14, and a paper supply unit 16.

In the MFP 10, the printer unit 11 forms an image on a sheet P in accordance with image data scanned by the scanner 8. The printer unit 11 forms toner images corresponding to image data, for example, by using stations 13Y, 13M, 13C and 13K of yellow (Y), magenta (M), cyan (C) and black (K), and then forms a color toner image on a transfer belt 11a. The printer unit 11 transfers, by a transfer unit 11b, the color toner image on the transfer belt 11a to the sheet P supplied from the paper supply unit 16. The printer unit 11 fixes the color toner image to the sheet P by a fixing unit 11c and discharges the sheet P from a paper discharge roller pair 12.

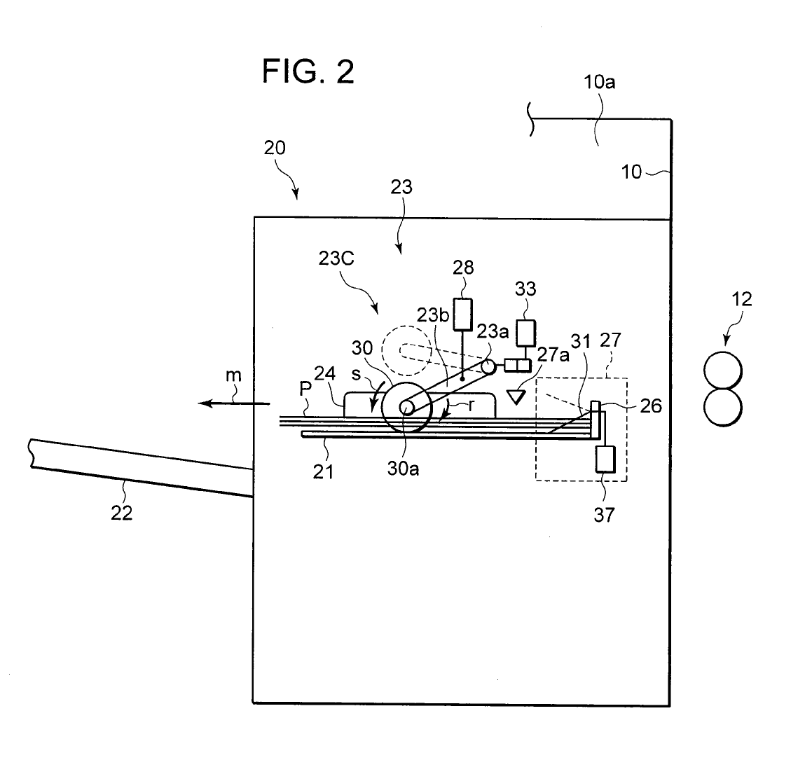

As shown in FIG. 2, the finisher 20 has a processing tray 21 as a supporting unit on which the sheet P supplied from the paper discharge roller pair 12 is placed for finishing, and a paper discharge tray 22 which houses the finished sheet P. The finisher 20 has an alignment unit 23 as a moving unit, and a lateral alignment board 24 and a longitudinal alignment board 26 as a positioning unit. The finisher 20 has, for example, a stapler 27 to staple the sheet as finishing, and a sensor 27a which detects a paper jam of the sheet P.

The alignment unit 23 has an alignment roller 23c at the distal end of an arm 23b rotating about a shaft 23a as a fulcrum. The arm 23b rotates according to the on-off operation of an arm solenoid 28. When the arm solenoid 28 is on, the arm 23b rotates as indicated by the dotted line in FIG. 2 and the alignment roller 23c moves away from the sheet P on the processing tray 21. When the arm solenoid 28 is off, the arm 23b rotates by its own weight as indicated by the solid line in FIG. 2 and the alignment roller 23c contacts the upper surface of the sheet P on the processing tray 21. The part of the alignment roller 23c that contact the sheet P is formed by an elastic tube 30.

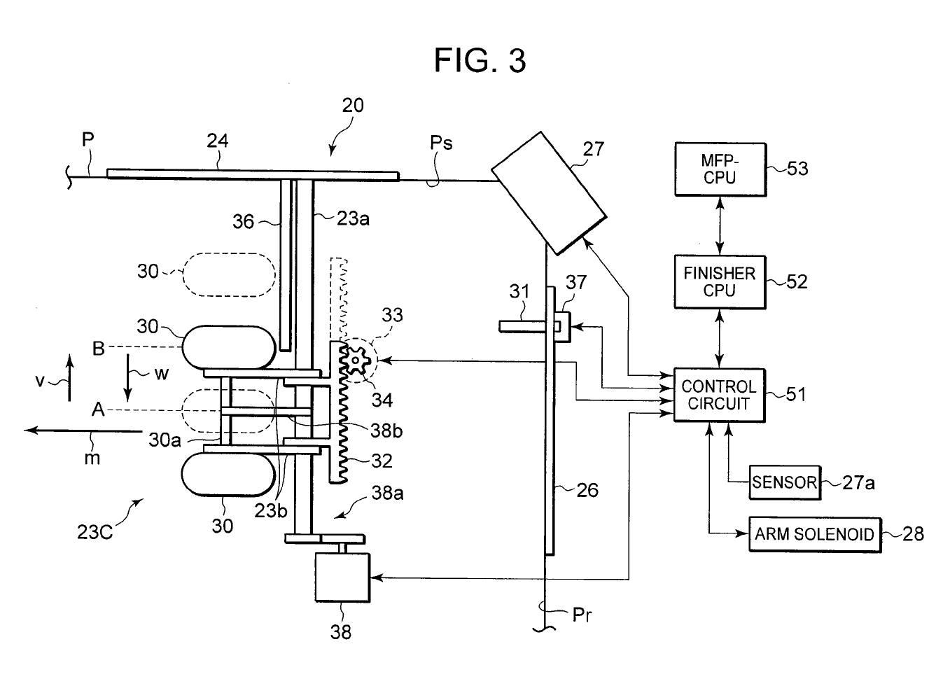

As shown in FIG. 3, a roller motor 38 rotates the alignment roller 23c forward and backward via a link gear 38a, the shaft 23a, a timing belt 38b and a roller shaft 30a. When carrying the sheet P, the alignment roller 23c rotates in the direction of arrow r in FIG. 2, which is a first direction. When longitudinally aligning the sheet P, the alignment roller 23c rotates in the direction of arrow s, which is a second direction. When laterally aligning the sheet P, the alignment roller 23c stops.

The alignment unit 23 slides in the direction that intersects the direction of arrow m, which is the carrying direction of the sheet P. As a rack 32 is slid by a pinion gear 34 driven by a gear motor 33, the arm 23b of the alignment unit 23 slides along the shaft 23a. The lateral alignment board 24 is located at a lateral edge of the processing tray 21 and is parallel to the carrying direction of the sheet P. At the time of alignment, the lateral edge Ps which is side edge of the sheet P is abutted against the lateral alignment board 24, and the lateral alignment board 24 thus laterally aligns the sheet P. The lateral alignment board 24 supports an adjustment bar 36 which is an adjustment unit and which is inclined in a manner of approaching the processing tray 21 as away from the lateral alignment board 24. The longitudinal alignment board 26 is located at the rear edge of the processing tray 21 and is perpendicular to the carrying direction of the sheet P. At the time of alignment, the rear edge Pr which is side edge of the sheet P is abutted against the longitudinal alignment board 26, and the longitudinal alignment board 26 thus longitudinally aligns the sheet P.

The finisher 20 has a chuck 31 which prevents the aligned sheet P from shifting on the processing tray 21. The chuck 31 opens and closes according to the on-off operation of a solenoid 37. When the solenoid 37 is on, the chuck 31 opens as indicated by the dotted line in FIG. 2. When the solenoid 37 is off, the chuck 31 closes as indicated by the solid line in FIG. 2. The chuck 31 is opened while the sheet P is longitudinally aligned on the processing tray 21. As the alignment of the sheet P is finished, the chuck 31 closes.

A control circuit 51 is controlled by a finisher CPU 52 which controls the finisher 20. The control circuit 51 and the finisher CPU 52 form the adjustment unit. The finisher CPU 52 is connected to an MFP-CPU 53 which controls the MFP 10. The control circuit 51 controls the stapler 27, the arm solenoid 28, the gear motor 33, the solenoid 37, and the roller motor 38. The result of detection by the sensor 27a is inputted to the control circuit 51.

When printing is started, the MFP 10 forms a color toner image on the sheet P and then discharges the sheet P toward the finisher 20. The finisher 20 receives the sheet P supplied from the MFP 10. While the sheet P is received, the alignment roller 23c of the finisher 20 is away from the processing tray 21.

(1) Case where Finishing of the Sheet P is not Carried Out

As the sensor 27a detects that the introduction of the sheet P onto the processing tray 21 is finished, the control circuit 51 turns off the arm solenoid 28 so that the alignment roller 23c is abutted against the sheet P. The control circuit 51 rotates the roller motor 38 forward and rotates the alignment roller 23c in the direction of arrow r. The alignment roller 23c carries the sheet P in the direction of arrow m and discharges the sheet P to the paper discharge tray 22.

(2) Case where, for Example, the Sheets P are Discharged as a Bundle, as Finishing of the Sheets P

As the sensor 27a detects that the introduction of the first sheet P onto the processing tray 21 is finished, the control circuit 51 turns on the solenoid 37 so that the chuck 31 opens, and the control circuit 51 turns off the arm solenoid 28 so that the alignment roller 23c is abutted against the first sheet P. The control circuit 51 rotates the roller motor 38 backward by a predetermined amount and rotates the alignment roller 23c in the direction of arrow s. The alignment roller 23c carries the sheet P in the direction opposite to the direction of arrow m, and the rear edge Pr of the sheet P is abutted against the longitudinal alignment board 26. Thus, the sheet P is longitudinally aligned.

The control circuit 51 rotates the gear motor 33 forward and slides the alignment unit 23 in the direction of arrow v from a position A to a position B (where both the position A and position B refer to the position of the center of the roller shaft 30a). In sliding, the alignment roller 23c moves the sheet P in the direction of arrow v by a frictional force, and the lateral edge Ps of the sheet P is abutted against the lateral alignment board 24. Thus, the sheet P is laterally aligned. From a halfway part of the sliding of the alignment unit 23 from the position A to the position B, the adjustment bar 36 and the arm 23b slide in contact with each other.

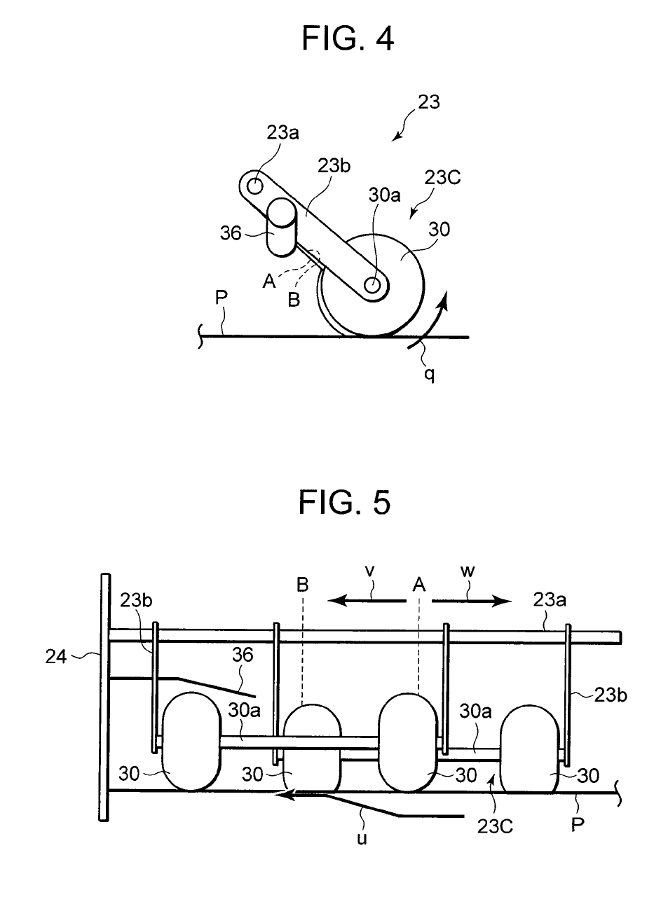

As shown in FIG. 4, the arm 23b rotates in the direction of arrow q along the inclination of the adjustment bar 36, from a halfway part of the sliding. As indicated by arrow u in FIG. 5, the roller shaft 30a rises in height from the surface of the processing tray 21. As the roller shaft 30a rises, the contact pressure of the alignment roller 23c to the sheet P, that is, its frictional force, is reduced. Therefore, the force of the alignment unit 23 to move the sheet P in the direction of arrow v weakens as the alignment unit 23 approaches the lateral alignment board 24. Since the alignment roller 23c is formed by the elastic tube 30, the alignment roller 23c remains in contact with the sheet P even if the roller shaft 30a is raised by the adjustment bar 36.

As the arm 23b is rotated by the adjustment bar 36, when the sheet P is abutted against the lateral alignment board 24, the pressure applied to the lateral edge Ps of the sheet P can be reduced and the amount of curvature generated in the sheet P can be decreased. At the time of lateral alignment, the rebounding of the sheet P due to the curvature of the sheet P can be restrained and misalignment can be solved. Moreover, generation of creases due to the application of a large pressure on the lateral edge Ps of the sheet P can be prevented.

As the longitudinal alignment and lateral alignment of the first sheet P is completed, the control circuit 51 turns off the solenoid 37 to close the chuck 31 and thus prevents the sheet P from shifting. The control circuit 51 turns on the arm solenoid 28 and rotates the gear motor 33 backward. The alignment roller 23c moves away from the sheet P. The alignment unit 23 slides in the direction of arrow w and returns from the position B to the position A.

The control circuit 51 aligns the second and subsequent sheets P on the processing tray 21 similarly to the case of the first sheet. When the alignment of a predetermined number of sheets P is completed, the control circuit 51 turns off the arm solenoid 28 and rotates the roller motor 38 forward. The alignment roller 23c discharges the sheets P on the processing tray 21 as a bundle to the paper discharge tray 22.

In the case of stapling the sheets P as finishing, a predetermined number of sheets P aligned on the processing tray 21 are stapled by the stapler 27 and discharged as a bundle to the paper discharge tray 22.

According to the first embodiment, while the sheet P is moved in the direction toward the lateral alignment board 24 by the alignment roller 23c, the roller shaft 30a is raised by the adjustment bar 36 and the force to move the sheet is thus weakened. Therefore, when the sheet P is abutted against the lateral alignment board 24 by the alignment unit 23, the pressure applied to the lateral edge Ps of the sheet P can be reduced and generation of creases at the lateral edge Ps of the sheet P can be prevented. The rebounding of the sheet P is restrained and thus alignment accuracy can be improved.

Next, a second embodiment will be described. In the second embodiment, the moving speed and the moving distance of the sheet by the alignment unit in the first embodiment are adjusted in accordance with the type of the sheet. In the second embodiment, the same parts of the configuration as those described in the first embodiment are denoted by the same reference numerals and will not be described further in detail.

The finisher CPU 52 adjusts the driving frequency and the driving timing of the gear motor 33 and the roller motor 38 by the control circuit 51 at the time of alignment, in accordance with sheet information from the MFP-CPU 53.

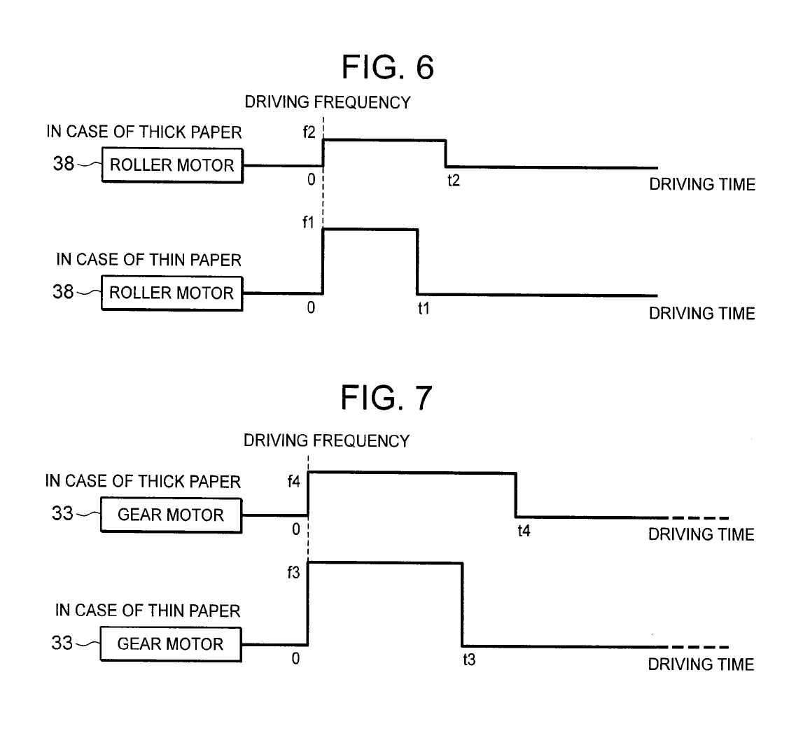

For example, the control circuit 51 adjusts the roller motor 38 in accordance with the thickness of the sheet P. When the sheet P is a normal paper as a first sheet which has amass of 64 to 80 g/m², the control circuit 51 rotates the roller motor 38 backward at a driving frequency f1 for a driving time t1 as shown in FIG. 6 so that the alignment roller 23c rotates for 150 ms as a third time at 200 nm/sec as a third speed, and thus longitudinally aligns the sheet. If When the sheet P is a thick paper as a second sheet which has a mass greater than 80 g/m², the control circuit 51 rotates the roller motor 38 backward at a driving frequency f2 for a driving time t2 as shown in FIG. 6 so that the alignment roller 23c rotates for a fourth time that is longer than the third time at a fourth speed that is lower than the third speed, and thus longitudinally aligns the sheet.

As the moving speed of the thick paper is made lower than that of the normal paper, the rebounding of the thick paper when abutted against the longitudinal alignment board 26 can be restrained. The thick paper can be aligned more securely if the driving time after the abutment against the longitudinal alignment board 26 is made longer. Moreover, since the thick paper does not easily flex, its rebounding due to flexure can be restrained even if the driving time is made longer.

Moreover, the control circuit 51 adjusts the gear motor 33 in accordance with the thickness of the sheet P. When the sheet P is a normal paper, the control circuit 51 rotates the gear motor 33 forward at a driving frequency f3 for a driving time t3 as shown in FIG. 7 so that the alignment unit slides in the direction of arrow v for 150 ms as a first time at 200 nm/sec as a first speed, and thus laterally aligns the sheet. When the sheet P is a thick paper, the control circuit 51 rotates the gear motor 33 forward at a driving frequency f4 for a driving time t4 so that the alignment unit 23 rotates for a second time that is longer than the first time at a second speed that is lower than the first speed, and thus laterally aligns the sheet.

As the sliding speed of the thick paper is made slower than that of the normal paper, the rebounding of the thick paper when abutted against the lateral alignment board 24 can be restrained. The thick paper can be aligned more securely if the driving time of the gear motor 33 after the abutment to the lateral alignment board 24 is made longer. Moreover, since the thick paper does not easily flex, its rebounding due to flexure can be restrained even if the moving time is made longer. Meanwhile, whether it is the normal paper or the thick paper, the arm 23b is rotated by the adjustment bar 36 from a halfway part of the slide movement, and the force to move the sheet P in the direction of arrow v by the alignment unit 23 is weakened. Therefore, when the sheet P is abutted against the lateral alignment board 24, the pressure applied to the lateral edge Ps of the sheet P can be reduced.

According to the second embodiment, the driving of the roller motor 38 at the time of longitudinal alignment and the driving of the gear motor 33 at the time of lateral alignment are adjusted differently between a normal paper and a thick paper. Therefore, even in the case of the thick paper, the rebounding from the longitudinal alignment board 26 or the lateral alignment board 24 is restrained and the sheet can be securely aligned along the longitudinal alignment board 26 or the lateral alignment board 24. Thus, alignment accuracy can be improved.

The invention is not limited to the embodiments and various changes and modifications can be made without departing from the scope of the invention. For example, the finishing carried out by the sheet finishing apparatus is not limited to stapling. The finishing can be punching, folding and so on. The shape and the driving mechanism of the moving unit or the like are not limited, either. The alignment roller may be made of an elastic material such as urethane foam. Also, the shape and the angle of inclination of the adjustment bar, or the mechanism to slide the alignment unit may be arbitrary.

What is claimed is:

1. A sheet finishing apparatus comprising:
a supporting unit which supports a sheet supplied from an image forming unit;
a positioning unit against which a side edge of the sheet placed on the supporting unit is abutted;
a moving unit which contacts a surface of the sheet placed on the supporting unit and moves the sheet in a direction toward the positioning unit; and
an adjustment unit which adjusts a movement mode of the moving unit.

2. The apparatus of claim 1, wherein the moving unit moves in a direction intersecting a carrying direction of the sheet and moves the sheet in the direction toward the positioning unit, and
the adjustment unit adjusts a contact pressure to the sheet from the moving unit moving in the direction intersecting the carrying direction of the sheet.

3. The apparatus of claim 2, wherein the adjustment unit reduces the contact pressure to the sheet from the moving unit as the moving unit approaches the positioning unit.

4. The apparatus of claim 3, wherein the moving unit has an arm that fluctuates with respect to the supporting unit, and a roller which is supported by the arm and contacts the sheet because of its own weight, and
the adjustment unit has an inclined member which slides in contact with the arm and separates the arm away from the supporting unit as the moving unit approaches the positioning unit.

5. The apparatus of claim 4, wherein the roller also serves as a carrying unit which carries the sheet in the carrying direction.

6. The apparatus of claim 1, wherein the adjustment unit adjusts the movement mode of the moving unit in accordance with a type of the sheet.

7. The apparatus of claim 6, wherein the adjustment unit adjusts the movement mode of the moving unit so that a moving speed of the sheet and the moving distance of the sheet by the moving unit are changed.

8. The apparatus of claim 7, wherein the moving unit moves in a direction intersecting a carrying direction of the sheet and moves the sheet in the direction toward the positioning unit, and
in the case of a first sheet, the adjustment unit adjusts the moving unit so that the moving unit moves at a first speed for a first time, and in the case of a second sheet that is thicker than the first sheet, the adjustment unit adjusts the moving unit so that the moving unit moves at a second speed that is lower than the first speed for a second time that is longer than the first time.

9. The apparatus of claim 8, wherein the moving unit has a roller which carries the sheet in the carrying direction.

10. The apparatus of claim 7, wherein the moving unit has a roller which rotates in a first direction and thus carries the sheet in a carrying direction, and rotates in a second direction that is opposite to the first direction and thus moves the sheet in the direction toward the positioning unit, and
in the case of a first sheet, the adjustment unit adjusts the roller so that the roller rotates in the second direction at a third speed for a third time, and in the case of a second sheet that is thicker than the first sheet, the adjustment unit adjusts the roller so that the roller rotates in the second direction at a fourth speed that is lower than the third speed for a fourth time that is longer than the third time.

11. An image forming apparatus comprising:
an image forming unit which forms an image on a sheet;
a supporting unit which supports the sheet having the image formed thereon by the image forming unit;
a positioning unit against which a side edge of the sheet placed on the supporting unit is abutted;
a moving unit which contacts a surface of the sheet placed on the supporting unit and moves the sheet in a direction toward the positioning unit; and
an adjustment unit which adjusts a movement mode of the moving unit.

12. The apparatus of claim 11, wherein the moving unit moves in a direction intersecting a carrying direction of the sheet and moves the sheet in the direction toward the positioning unit, and
the adjustment unit reduces a contact pressure to the sheet from the moving unit moving as the moving unit approaches the positioning unit.

13. The apparatus of claim 12, wherein the moving unit has an arm that fluctuates with respect to the supporting unit, and a roller which is supported by the arm and contacts the sheet because of its own weight, and
the adjustment unit has an inclined member which slides in contact with the arm and separates the arm away from the supporting unit as the moving unit approaches the positioning unit.

14. The apparatus of claim 11, wherein the adjustment unit adjusts the movement mode of the moving unit so that a moving speed of the sheet and the moving distance of the sheet by the moving unit are changed in accordance with a type of the sheet.

15. The apparatus of claim 14, wherein the moving unit moves in a direction intersecting a carrying direction of the sheet and moves the sheet in the direction toward the positioning unit, and
in the case of a first sheet, the adjustment unit adjusts the moving unit so that the moving unit moves at a first speed for a first time, and in the case of a second sheet that is thicker than the first sheet, the adjustment unit adjusts the moving unit so that the moving unit moves at a second speed that is lower than the first speed for a second time that is longer than the first time.

16. The apparatus of claim 14, wherein the moving unit has a roller which rotates in a first direction and thus carries the sheet in a carrying direction, and rotates in a second direction that is opposite to the first direction and thus moves the sheet in the direction toward the positioning unit, and
in the case of a first sheet, the adjustment unit adjusts the roller so that the roller rotates in the second direction at a third speed for a third time, and in the case of a second sheet that is thicker than the first sheet, the adjustment unit adjusts the roller so that the roller rotates in the second direction at a fourth speed that is lower than the third speed for a fourth time that is longer than the third time.

17. An alignment method for a sheet finishing apparatus comprising:
placing a sheet discharged from an image forming unit, on a supporting unit;
causing a moving unit to contact a surface of the sheet placed on the supporting unit, then moving the sheet in a direction toward a positioning unit, and abutting a side edge of the sheet against the positioning unit; and
adjusting a movement mode when moving the sheet in the direction toward the positioning unit.

18. The method of claim 17, wherein the direction toward the positioning unit is a direction intersecting a carrying direction of the sheet, and
in adjusting the movement mode, a contact pressure to the sheet from the moving unit is reduced as the moving unit approaches the positioning unit.

19. The method of claim 17, wherein in adjusting the movement mode, a moving speed of the sheet and a moving distance of the sheet by the moving unit are changed in accordance with a type of the sheet.

20. The method of claim 19, wherein the direction toward the positioning unit is a direction intersecting a carrying direction of the sheet, and
in adjusting the movement mode, in the case of a first sheet, the moving unit is moved at a first speed for a first time, and in the case of a second sheet that is thicker than the first sheet, the moving unit is moved at a second speed that is lower than the first speed for a second time that is longer than the first time.
